(19) United States
(12) Patent Application Publication
(10) Pub. No.: US 2016/0081097 A1
(43) Pub. Date: Mar. 17, 2016

(54) QoE-AWARE SCHEDULING METHOD AND APPARATUS

(71) Applicant: ELECTRONICS AND TELECOMMUNICATIONS RESEARCH INSTITUTE, Daejeon (KR)

(72) Inventors: Yunhee CHO, Daejeon (KR); Jae Su SONG, Daejeon (KR); Seung-Hwan LEE, Daejeon (KR)

(73) Assignee: ELECTRONICS AND TELECOMMUNICATIONS RESEARCH INSTITUTE, Daejeon (KR)

(21) Appl. No.: 14/844,537

(22) Filed: Sep. 3, 2015

(30) Foreign Application Priority Data
Sep. 12, 2014 (KR) 10-2014-0121338

(51) Int. Cl. H04W 72/08; H04W 72/12; H04L 5/00; H04W 24/02

(52) U.S. Cl. CPC H04W 72/08; H04W 24/02; H04W 72/12; H04L 5/0057; H04W 88/02

(57) ABSTRACT

A QoE-aware scheduling method for a wireless network is provided. The scheduling method includes: acquiring application information about a service to be run on a terminal included in the wireless network; creating an MOS model based on the application information; and scheduling wireless network resources for the terminal based on the MOS model.

### CROSS-REFERENCE TO RELATED APPLICATION

This application claims priority to and the benefit of Korean Patent Application No. 10-2014-0121338 filed in the Korean Intellectual Property Office on Sep. 12, 2014, the entire contents of which are incorporated herein by reference.

### BACKGROUND OF THE INVENTION

(a) Field of the Invention

The present invention relates to a quality of experience-aware scheduling method and apparatus for a wireless network.

(b) Description of the Related Art

With the recent diversification of video content, its features, and mobile display resolutions, requirements of mobile video services also are becoming diversified. This is because of large screens and high data rates required for dynamic video services. Hence, each individual user's quality of experience (QoE) may differ even with the same data rate, depending on what content the user is served and the performance of the user's terminal. Such non-linearity between data rate and QoE will become more evident as video content and mobile terminal types are further diversified. Therefore, more emphasis will be placed on QoE-aware resource allocation.

In general, QoE is evaluated by mean opinion score (MOS). The MOS is expressed in a range 1 to 5 or a range 1 to 4.5. Table 1 shows the relationship between MOS and user satisfaction.

TABLE 1

| MOS | User satisfaction |
|---|---|
| 4.5 | Excellent |
| 4 | Good |
| 3 | Acceptable |
| 2 | Bad |
| 1 | Very Bad |

Conventional mobile communication systems generally use a scheduling technique that maximizes the sum of data rates of users, or a proportional fair scheduling technique that is aware of data rates and fairness among users. Further, in terms of delays, scheduling techniques that minimize delays or are aware of user delays and fairness are frequently used. These scheduling techniques are adopted and implemented to ensure quality of service (QoS) and therefore provide the highest QoS.

QoE can be expressed as a function of QoS (QoE=f(QoS)), but QoE and QoS do not have a linear relationship. FIG. 1 is a graph showing the relationship between data rate and MOS. Accordingly, the above scheduling techniques can offer satisfactory QoE to some extent under the condition that every user is served with the same type of service. For example, assuming that every user is being served with a best effort file transfer protocol (best effort FTP) service, the existing proportional fair scheduling technique alone can offer satisfactory QoE to some extent if it works in a specific area.

However, QoS alone is not enough to offer satisfactory QoE in recent times, when mobile device performance and mobile internet service types become diversified. Conventionally, research on QoE-aware scheduling techniques has been conducted on the basis of research on functional correspondence between QoS and QoE. Although many QoE-aware scheduling techniques for achieving a maximum or minimum MOS have been suggested, this research only deals with situations where no channel change occurs, due to the non-differentiability of MOS functions.

### SUMMARY OF THE INVENTION

The present invention has been made in an effort to provide a QoE-aware scheduling method and apparatus which offer satisfactory quality of experience with various mobile devices and various internet services.

An exemplary embodiment of the present invention provides a QoE-aware scheduling method for a wireless network. The scheduling method includes: acquiring application information about a service to be run on a terminal included in the wireless network; creating an MOS model based on the application information; and scheduling wireless network resources for the terminal based on the MOS model.

The creating of an MOS model may include: determining a plurality of curve segment ranges each including non-differentiable points in a first MOS model expressed by a non-differentiable function; and deleting the non-differentiable points by applying an n-th Bezier curve to each of the curve segment ranges.

The deleting of the non-differentiable points may include: determining (n+1) control points in each of the curve segment ranges; and drawing an n-th Bezier curve by joining the (n+1) control points and determining the drawn n-th Bezier curve as the MOS model for each of the curve segment ranges.

The MOS model may be expressed by a Bezier curve parameter and a function of data rate in a wireless network, which may be continuously differentiable in the entire range of data rates.

The scheduling may include: receiving CSI from the terminal; and calculating the data rate available on every subchannel allocated to the user based on the CSI.

The scheduling may further include: calculating an average data rate using a scheduling indicator vector and an available data rate; and scheduling wireless network resources based on the user's priority, the MOS model, and the average data rate.

The scheduling may include applying a gradient scheduling technique to the user's priority, the MOS model, and the average data rate.

The scheduling indicator vector may be 0 if a base station allocates a specific subchannel and a specific time slot to the user, and otherwise is 1.

An exemplary embodiment of the present invention provides a QoE-aware scheduling apparatus for a wireless network. The scheduling apparatus may include: an MOS modeling processor that acquires application information about a service run on a terminal included in the wireless network and creates an MOS model based on the application information; and a QoE-aware scheduler that schedules wireless network resources for the terminal based on the MOS model.

The MOS modeling processor may determine a plurality of curve segment ranges each including non-differentiable points in an existing MOS model expressed by a non-differentiable function, and delete the non-differentiable points by applying an n-th Bezier curve to each of the curve segment ranges.

The MOS modeling processor may determine (n+1) control points in each of the curve segment ranges, draw an n-th Bezier curve by joining the (n+1) control points, and determine the drawn n-th Bezier curve as the MOS model for each of the curve segment ranges.

The MOS model may be expressed by a Bezier curve parameter and a function of data rate in a wireless network, which may be continuously differentiable in the entire range of data rates.

The scheduling apparatus may further include a CSI collector that receives CSI from the terminal, wherein the QoE-aware scheduler may calculate the data rate available on every subchannel allocated to the user based on the CSI.

The QoE-aware scheduler may calculate an average data rate using a scheduling indicator vector and an available data rate, and schedule wireless network resources based on the user's priority, the MOS model, and the average data rate.

The QoE-aware scheduler may apply a gradient scheduling technique to the user's priority, the MOS model, and the average data rate.

The scheduling indicator vector may be 0 if a base station allocates a specific subchannel and a specific time slot to the user, and is otherwise 1.

Another exemplary embodiment of the present invention provides a QoE-aware scheduling method for a wireless network. The scheduling method includes: creating a MOS model based on application information about a service to be run on a terminal included in the wireless network; generating a PF utility function based on the MOS model; and scheduling wireless network resources for the terminal based on the PF utility function.

The generating of a PF utility function may include generating a concave PF utility function.

The scheduling may include scheduling wireless network resources for the terminal based the utility function by using adaptive FTR.

The scheduling may include: modifying the PF utility function by taking into consideration at least one of average quality of experience, a fairness factor for users, and user's priority; and scheduling wireless network resources for the terminal based on the modified utility function.

### BRIEF DESCRIPTION OF THE DRAWINGS

FIG. 1 is a graph showing the relationship between data rate and MOS.

FIG. 2 is a graph showing an MOS model of video service.

FIG. 3 is a graph showing an MOS model of file download service.

FIG. 4 is a view showing a continuously differentiable MOS model according to an exemplary embodiment of the present invention.

FIG. 5 is a view showing an MOS model according to an exemplary embodiment of the present invention.

FIG. 6 and FIG. 7 are graphs showing the performance of a QoE-aware scheduling method versus the number of users within a cell according to an exemplary embodiment of the present invention.

FIG. 8 is a view showing a continuously differentiable MOS model according to another exemplary embodiment of the present invention.

FIG. 9 is a view showing a plurality of MOS models using a varied control parameter m₀ according to another exemplary embodiment of the present invention.

FIG. 10 is a view showing the MOS performance versus number of cell users in heterogeneous user groups.

FIG. 11 is a view showing the MOS performance of the bottom 5% versus a number of cell users in heterogeneous user groups.

FIG. 12 is a view showing a system to which a QoE-based scheduling method according to an exemplary embodiment of the present invention is applied.

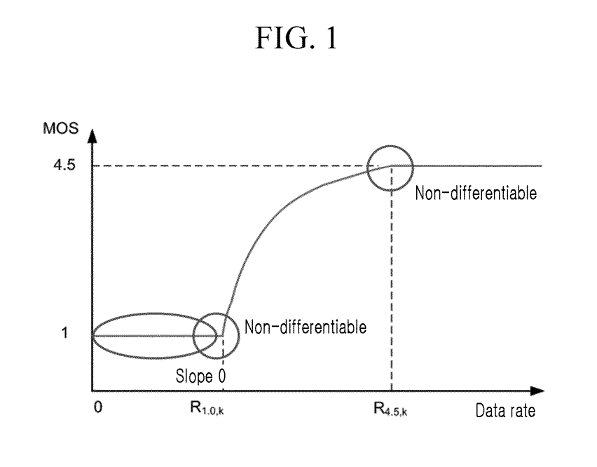

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, a mobile station MS may indicate a terminal, a mobile terminal (MT), an advanced mobile station (AMS), a high reliability mobile station (HR-MS), a subscriber station (SS), a portable subscriber station (PSS), an access terminal (AT), and user equipment (UE), and it may include entire or partial functions of the MT, MS, AMS, HR-MS, SS, PSS, AT, and UE.

In the specification, a base station (BS) may indicate an advanced base station (ABS), a high reliability base station (HR-BS), a node B (NodeB), an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, and a small base station [such as a femto base station (femto BS), a home node B (HNB), a home eNodeB (HeNB), a pico base station (pico BS), a metro base station (metro BS), or a micro base station (micro BS)], and it may include entire or partial functions of the ABS, nodeB, eNodeB, AP, RAS, BTS, MMR-BS, RS, RN, ARS, HR-RS, and small base station.

Parameters for video service and file download service are determined by service characteristics. An MOS model of the video service can be expressed by the following Equation 1.

$${MOS}_{k}^{n} ( {\overline{R}}_{k}^{n} ) = \{ \begin{matrix}1 \text{:} & {\overline{R}}_{k}^{n} \leq {R}_{1.0 , k}^{n} , \\ {MOS}_{0 , k}^{n} log \frac{{\overline{R}}_{k}^{n}}{{R}_{0 , k}^{n}} \text{:} & {R}_{1.0 , k}^{n} < {\overline{R}}_{k}^{n} < {R}_{4.5 , k}^{n} , \\ 4.5 \text{:} & {\overline{R}}_{k}^{n} \geq {R}_{4.5 , k}^{n}\end{matrix} \qquad ( Equation 1 )$$

An MOS model of the file download service can be expressed by the following Equation 2.

$${MOS}_{FD} = \{ \begin{matrix}1.0 , & R < 10 kbps \\ α {log}_{10} ( β R ) , & 10 kbps \leq R < 300 kbps \\ 4.5 , & 300 kbps < R\end{matrix} \qquad ( Equation 2 )$$

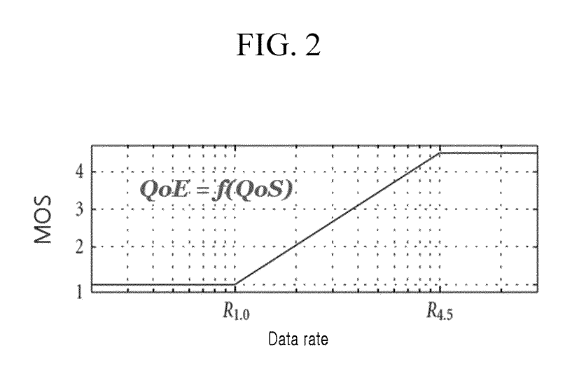

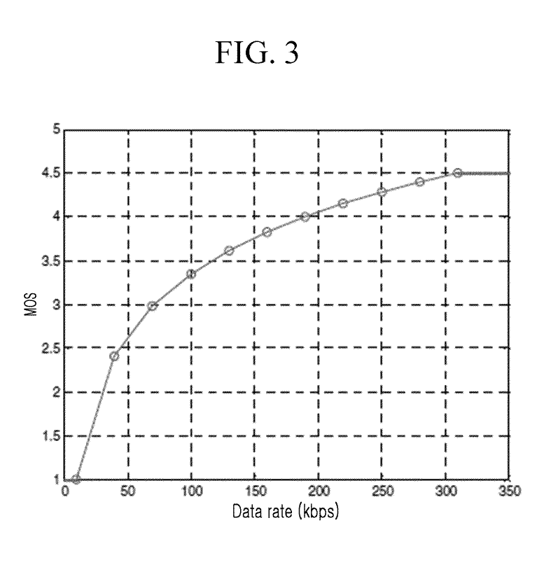

FIG. 2 is a graph showing an MOS model of video service, and FIG. 3 is a graph showing an MOS model of file download service.

As can be seen from FIG. 2 and FIG. 3, the graph of a conventional MOS model represents a bounded logarithmic function, and is non-differentiable at each boundary. Accordingly, the present invention suggests an MOS model that is differentiable everywhere, which will be described by taking an Orthogonal Frequency Division Multiplexing (OFDM) system as an example. A differentiable MOS model according to an exemplary embodiment of the present invention is applicable to wired/wireless networks such as broadcast networks, as well as to OFDM systems, and the scope of application is not limited to wireless networks.

In a conventional QoS-aware scheduling technique, a base station allocates radio resources as in Equation 3, in order to maximize each user's level of satisfaction with service. One of the most typical QoS-aware scheduling techniques is proportional fairness scheduling that is aware of total system throughput and fairness among users.

$$max {\sum }_{k ∈ {𝒦}_{n}} {U}_{k}^{n} ( {\overline{R}}_{k}^{n} ) \qquad ( Equation 3 )$$

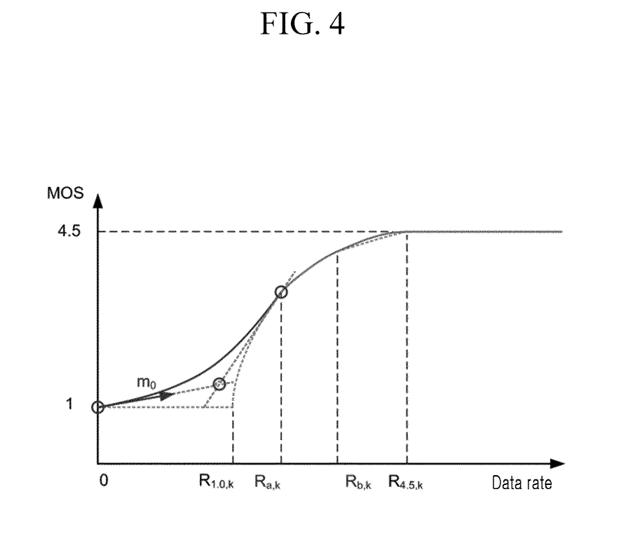

FIG. 4 is a view showing a continuously differentiable MOS model according to an exemplary embodiment of the present invention.

The slope at R̅ₖⁿ on a conventional MOS graph (dotted line) of FIG. 4 is denoted by m₀. In the conventional MOS model, the highest data rate, i.e., a data rate threshold, at an MOS of 1 is R_{1.0,k}, and the data rate at an MOS of 4.5 is R_{4.5,k}. The conventional MOS model is discontinuous at R_{1.0,k} and R_{4.5,k}.

In an exemplary embodiment of the present invention, ranges each including two non-differentiable points in the conventional MOS model are determined in order to create a MOS model of a continuously differentiable function.

These ranges are referred to as curve segment ranges and include [0, R_{a,k}] and [R_{b,k}, R_{4.5,k}], and their data rates bound are R_{a,k} and R_{b,k}, respectively. The data rates indicated in FIG. 4 have a relationship as shown in the following Equation 4.

0≦R_{1.0,k}ⁿ≦R_{a,k}ⁿ≦R_{b,k}ⁿ≦R_{4.5,k}ⁿ (Equation 4)

In the exemplary embodiment of the present invention, second-order Bezier curves are used to create a continuously differentiable MOS model by modifying the curve segment ranges. To create a continuously differentiable MOS model by using Bezier curves, control points for expressing a curve segment range must be determined.

In the exemplary embodiment of the present invention, the x coordinate of a control point for drawing a Bezier curve indicates a specific data rate, and the y coordinate of the control point indicates the MOS. In the exemplary embodiment of the present invention, a continuously differentiable MOS model is created using a second-order Bezier curve drawn through three control points. Each of the control points in the conventional MOS model can be a point of intersection where two tangents at the boundary points of each curve segment range meet.

Referring to FIG. 4, the point of intersection where the two tangents at the left boundary point (R=0) and right boundary point (R=R_{a,k}) of the first curve segment range [0, R_{a,k}] meet is determined as the third control point. Provided that the slope of the tangent at the left boundary point (R=0) is denoted by mₐ and that the slope of the tangent at the right boundary point (R=R_{a,k}) is denoted by m_{b}, the third control point in the first curve segment range is given by Equation 5.

(R_{ca,k},m₀R_{ca,k}+1) (Equation 5)

Herein, Rⁿ_{ca,k} can be calculated by the following Equation 6.

$${R}_{ca , k}^{n} = \frac{- {m}_{a} {R}_{a , k}^{n} + {MOS}_{k}^{n} ( {R}_{a , k}^{n} ) - 1}{{m}_{0} - {m}_{a}} \qquad ( Equation 6 )$$

By applying the same procedure as the first curve segment range, the third control point in the second curve segment range is given by the following Equation 7. Rⁿ_{cb,k} can be calculated by the following Equation 8.

$$\begin{matrix}( {R}_{cb , k} , 4.5 ) & ( Equation 7 ) \\ {R}_{cb , k}^{n} = \frac{4.5 - {MOS}_{k}^{n} ( {R}_{b , k}^{n} )}{{m}_{b}} + {R}_{b , k}^{n} & ( Equation 8 )\end{matrix}$$

Accordingly, a continuously differentiable MOS model can be obtained by combining the Bezier curves of the two curve segment ranges and the curves of the conventional MOS model together. Through this modeling procedure, a continuously differentiable MOS model [symbol] ₖⁿ( R̅ₖⁿ) can be calculated by the following Equation 9.

$${k}_{n}^{} ( {\overline{R}}_{k}^{n} ) = \{ \begin{matrix}\begin{matrix}{( 1 - p )}^{2} 1 + 2 p ( 1 - p ) ( {m}_{0} {R}_{ca , k}^{n} + 1 ) + {p}^{2} {MOS}_{k}^{n} ( {R}_{a , k}^{n} ) , \\ where {\overline{R}}_{k}^{n} = {( 1 - p )}^{2} 0 + 2 p ( 1 - p ) {R}_{ca , k}^{n} + {p}^{2} {R}_{a , k}^{n}\end{matrix} , & if {\overline{R}}_{k}^{n} \leq {R}_{a , k}^{n} \\ {MOS}_{0 , k}^{n} log \frac{{\overline{R}}_{k}^{n}}{{R}_{0 , k}^{n}} , & if {R}_{a , k}^{n} < {\overline{R}}_{k}^{n} < {R}_{b , k}^{n} \\ \begin{matrix}{( 1 - p )}^{2} {MOS}_{k}^{n} ( {R}_{b , k}^{n} ) + 2 p ( 1 - p ) 4.5 + {p}^{2} 4.5 , \\ where {\overline{R}}_{k}^{n} = {( 1 - p )}^{2} {R}_{b , k}^{n} + 2 p ( 1 - p ) {R}_{cb , k}^{n} + {p}^{2} {R}_{4.5 , k}^{n}\end{matrix} , & if {R}_{b , k}^{n} \leq {\overline{R}}_{k}^{n} < {R}_{4.5 , k}^{n } \\ 4.5 , & if {\overline{R}}_{k}^{n} \geq {R}_{4.5 , k}^{n } .\end{matrix} \qquad ( Equation 9 )$$

Herein, p is a Bezier curve parameter, which is in the range of 0≦p≦1.

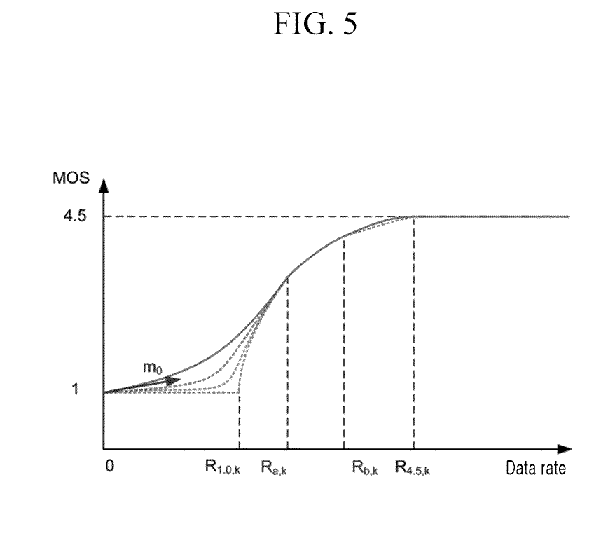

FIG. 5 is a view showing an MOS model according to an exemplary embodiment of the present invention.

Referring to FIG. 5, different MOS models can be created by adjusting the slope of the tangent at R̅ₖⁿ=0 according to an exemplary embodiment of the present invention. All the MOS models created in FIG. 5 are continuously differentiable in the entire range of data rates.

By applying an MOS model according to an exemplary embodiment of the present invention to QoE-aware scheduling, a scheduling method that maximizes average quality of experience and a scheduling method that is aware of user fairness while maximizing average quality of experience can be modeled according to Equation 10 and Equation 11, respectively.

max [symbol] ₙωₖ [symbol] ₖⁿ( R̅ₖⁿ) (Equation 10)

max [symbol] ₙωₖ log [symbol] ₖⁿ( R̅ₖⁿ(t)) (Equation 11)

Herein, ωₖ(ωₖ≧0) indicates the priority of user k.

Hereinafter, the scheduling method that is aware of fairness among users and uses an MOS model to maximize average quality of experience according to the exemplary embodiment of the present invention will be described.

N indicates a set of base stations (BSₛ), K indicates a set of users, and it is assumed that each user is associated with only one base station. Kₙ indicates a set of users associated with BSₙ, and S({1, . . . , s}) indicates a set of subchannels. Provided that the transmission power of BSₙ is denoted by Pⁿ, the transmission power pⁿₛ in subchannel s is denoted by Pⁿ/S. Accordingly, the same transmission power is allocated to every subchannel.

The signal-to-interference plus noise ratio (SINR) for user k on subchannel s of BSₙ at time slot t is given by Equation 12.

$${SINR}_{k , s}^{n} ( t ) = \frac{{p}_{s}^{n} {G}_{k , s}^{n} ( t )}{{σ}_{k , s}^{n} + {\sum }_{j ∈ 𝒩 , j \neq n} {p}_{s}^{j} {G}_{k , s}^{j} ( t )} , \qquad ( Equation 12 )$$

Herein, G_{k,s}ⁿ(t) is the channel gain between BSₙ and user k, and σ_{k,s}ⁿ is noise power. According to Shannon's law, the data rate available on channel s for user k is given by Equation 13.

$${r}_{k , s}^{n} ( t ) = \frac{B}{S} {log}_{2} ( 1 + γ {SINR}_{k , s}^{n} ( t ) ) \qquad ( Equation 13 )$$

Herein, B is the bandwidth of the system, and y is the difference between SINR and capacity, which is determined by a target bit error rate (target BER). It is assumed that each BSₙ is aware of the data rates available on every subchannel allocated to each user through channel state information (CSI) feedback.

A user scheduling indicator vector is defined as I(t), and I(t) is given by Equation 14.

I(t)=[I_{k,s}ⁿ(t):nε [symbol] ,kε [symbol] ₙ,sε [symbol] ] (Equation 14)

For example, if BSₙ allocates subchannel s and time slot t to an associated user, I_{k,s}ⁿ(t)=1; otherwise, I_{k,s}ⁿ(t)=0. As each BSₙ cannot schedule more than one user per time slot and per subchannel, I_{k,s}ⁿ(t) is subject to the constraint given by Equation 15.

$${\sum }_{k ∈ {𝒦}_{n}} {I}_{k , s}^{n} ( t ) \leq 1 , ∀ n ∈ 𝒩 , s ∈ 𝒮 . \qquad ( Equation 15 )$$

Hence, the actual data rate available for user k at time slot t can be expressed by Equation 16.

Rₖⁿ(t)= [symbol] I_{k,s}ⁿ(t)r_{k,s}ⁿ(t) (Equation 16)

The average data rate R̅ₖⁿ until time slot t can be expressed by Equation 17.

$${\overline{R}}_{k}^{n} ( t ) = \frac{1}{t} {\sum }_{τ = 1}^{t} {R}_{k}^{n} ( τ ) \qquad ( Equation 17 )$$

Now, based upon Equations 9 to 17, optimization problems for determining a scheduling method that maximizes quality of experience and is aware of fairness among users can be defined by Equation 18.

$${max}_{I ( t )} {\sum }_{s ∈ 𝒮} {\sum }_{k ∈ {𝒦}_{n}} {ω}_{k} {LMOS}_{k}^{n} ( {\overline{R}}_{k}^{n} ( t - 1 ) ) {r}_{k , s , l}^{n} ( t ) {I}_{k , s , l}^{n} ( t ) \\ subject to {\sum }_{k ∈ {𝒦}_{n}} {I}_{k , s , l}^{n} ( t ) \leq 1 ∀ s ∈ 𝒮 . \qquad ( Equation 18 )$$

Herein, LMOSₖⁿ( n̅ₖⁿ(t)) equals log [symbol] ₖⁿ ( n̅ₖⁿ(t)), and wₖ(wₖ≧0) indicates the priority of user k.

As the MOS model according to the exemplary embodiment of the present invention is a continuously differentiable MOS function, the best scheduling method for given BSₙ and subchannel s can be determined as in Equation 19 by applying a gradient scheduling technique to the MOS model of this invention.

$${I}_{k , s}^{n} ( t ) = \{ \begin{matrix}1 , & if k = arg {max}_{k ∈ {𝒦}_{n}} {ω}_{k} ∇ {LMOS}_{k}^{n} ( {\overline{R}}_{k}^{n} ( t - 1 ) ) {r}_{k , s}^{n} ( t ) , \\ 0 , & otherwise\end{matrix} . \qquad ( Equation 19 )$$

That is, according to the exemplary embodiment of the present invention, when choosing a user who satisfies Equation 19 for each subchannel at each time slot, the scheduler of each base station can achieve a maximum MOS for the chosen user and fairness among users.

Table 2 shows a simulation environment for evaluating a QoE-aware scheduling method according to an exemplary embodiment of the present invention.

TABLE 2

| <parameter> | <Assumed value> |
|---|---|
| cell layout | 19 hexagonal cells |
| cell coverage radius | 1000 meters |
| number of subchannels | 16 |
| carrier frequency | 2.3 GHz |
| system bandwidth | 10 MHz |
| thermal noise density | −174 dBm/H |
| target BER | 0.001 |
| time slot length | 1 ms |
| maximum transmission | 20 W |
| power | |
| radio loss model | PL(dₖ) = 16.62 + 37.6 1og₁₀(dₖ[m]) [dB] |
| channel model | Jakes' Rayleigh fading model |
| user distribution | uniform distribution |
| simulation time | 10,000 time slots |
| performance comparison | MOS |
| | MOS of bottom 5% |

To evaluate a scheduling method according to an exemplary embodiment of the present invention, the MOS of all users and the MOS of the bottom 5% (5^{th} percentile MOS) were used. For performance comparison, the QoE-aware scheduling method was compared with the existing proportional fair scheduling method.

Table 3 shows a scenario for performance analysis of a scheduling method according to an exemplary embodiment of the present invention.

Table 3 states the number (3) of user groups viewing video service provided according to the scheduling method according to the exemplary embodiment of the present invention, the numbers (4:3:3) of users in each user group, and the type of video service each user group is viewing. That is, in this evaluation, each user is divided into three user groups, and each user group is served with a different video service.

TABLE 3

| Scenario | Parameter | Setting |
|---|---|---|
| Scenario 1 | Number of user group | 1 |
| | Application | Container |
| Scenario 2 | Number of user group | 2 |
| | User ratio for each group | 5:5 |
| | Application for the group 1 | News |
| | Application for the group 2 | Container |
| Scenario 3 | Number of user group | 3 |
| | User ratio for each group | 4:3:3 |
| | Application for the group 1 | Foreman |
| | Application for the group 2 | Mother |
| | Application for the group 3 | News |

Table 4 shows the parameters of an MOS model for performance analysis of a scheduling method according to an exemplary embodiment of the present invention. That is, the video service provided to each user group has different service requirements.

TABLE 4

| Video name | R_{1.0,k}ⁿ | R_{4.5,k}ⁿ |
|---|---|---|
| Foreman | 120 | 2,156 |
| Mother | 17 | 447 |
| news | 58 | 638 |
| Container | 53 | 1,159 |
| Salesman | 57 | 2,265 |
| Bus | 592 | 4,141 |
| City | 169 | 2,202 |
| Crew | 178 | 2,677 |

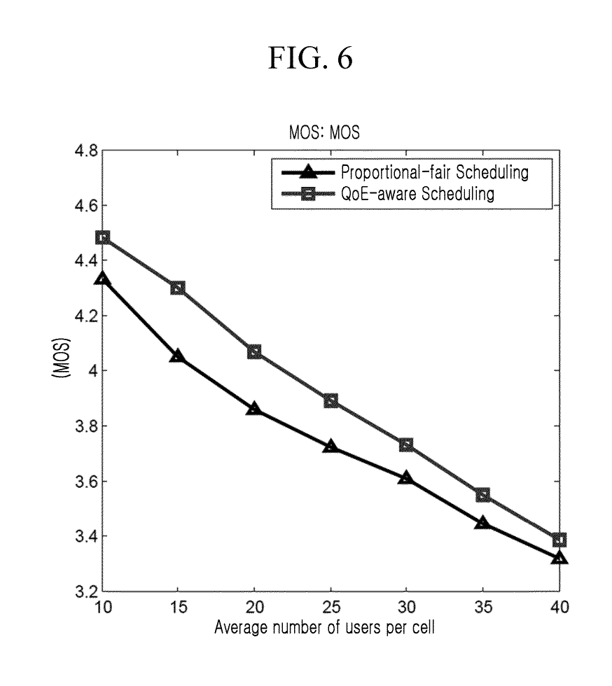

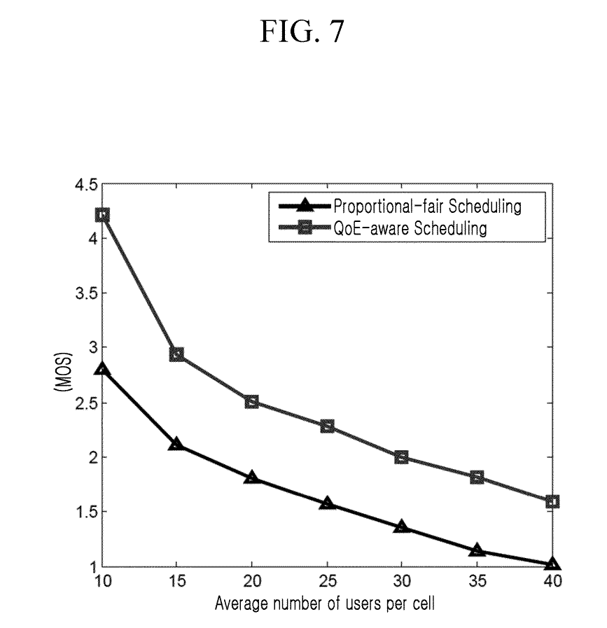

FIG. 6 and FIG. 7 are graphs showing the performance of a QoE-aware scheduling method versus the number of users within a cell according to an exemplary embodiment of the present invention.

FIG. 6 shows a comparison of MOS between the QoE-aware scheduling method and the proportional fair scheduling method, and FIG. 7 shows a comparison of MOS of the bottom 5% between the QoE-aware scheduling method and the proportional fair scheduling method.

Referring to FIG. 6 and FIG. 7, the QoE-aware scheduling method according to the exemplary embodiment of the present invention maintains the optimal performance in terms of MOS and exhibits a significant improvement of 50% or more compared to the proportional fair scheduling method in terms of MOS of the bottom 5%. That is, quality of experience can be maximized through the QoE-aware scheduling method according to the exemplary embodiment of the present invention. Using the QoE-aware scheduling method, a base station according to an exemplary embodiment of the present invention can achieve performance gain as above by allocating limited radio resources in such a way so as to maximize quality of experience in proportion to input resources, taking quality of experience into consideration.

Next, a scheduling method and apparatus according to another exemplary embodiment of the present invention will be described. The scheduling method and apparatus according to the other exemplary embodiment of the present invention are applicable to multi-cell OFDM networks. The scheduling method and apparatus according to the other exemplary embodiment of the present invention are also applicable to a single base station for an OFDMA system, as well as to multi-cell OFDMA networks.

N indicates a set of base stations (BSs), and K indicates a set of users. It is assumed that each user is associated with only one base station. K−ₙ indicates a set of users associated with BSₙ, and S({1, . . . , s}) indicates a set of subchannels. Provided that the transmission power of BSₙ is denoted by Pⁿ, the transmission power pⁿₛ at s (sεS) included in the subchannel set S is allocated equally to every channel.

The SINR for user k on subchannel s of BSₙ at time slot t is given by the following Equation 20.

$${SINR}_{k , s}^{n} ( t ) = \frac{{p}_{s}^{n} {G}_{k , s}^{n} ( t )}{{σ}_{k , s}^{n} + {\sum }_{j ∈ 𝒩 , j \neq n} {p}_{s}^{j} {G}_{k , s}^{j} ( t )} \qquad ( Equation 20 )$$

Herein, G_{k,s}ⁿ(t) is the channel gain between BSₙ and user k, and is noise power. According to Shannon's law, the achievable data rate for user k on subchannel s of BSₙ is given by the following Equation 21.

$${r}_{k , s}^{n} ( t ) = \frac{B}{S} {log}_{2} ( 1 + γ {SINR}_{k , s}^{n} ( t ) ) \qquad ( Equation 21 )$$

Herein, B is the bandwidth of the system, and y is the difference between SINR and capacity, which is determined by the target bit error rate (target BER). In another exemplary embodiment of the present invention, it is assumed that each BSₙ is aware of the instantaneous achievable data rate on every channel for every user through channel state information feedback.

In another exemplary embodiment of the present invention, a user scheduling indicator vector is defined as l(t)=[I_{k,s}ⁿ(t):nε [symbol] ,kε [symbol] ,sε [symbol] ]. For example, if I_{k,s}ⁿ(t)=1, BSₙ allocates associated user k to time slot t for subchannel s. If BSₙ does not allocate the user to time slot t for subchannel s, l(t) equals 0. As each BSₙ cannot schedule more than one user for each subchannel per time slot, I_{k,s}ⁿ(t) is subject to the constraint given by Equation 22.

$${\sum }_{k ∈ {𝒦}_{n}} {I}_{k , s}^{n} ( t ) \leq 1 , ∀ n ∈ 𝒩 , s ∈ 𝒮 . \qquad ( Equation 22 )$$

The actual data rate for user k at time slot t can be expressed by Equation 23.

$${R}_{k}^{n} ( t ) = {\sum }_{s ∈ 𝒮} {I}_{k , s}^{n} ( t ) {r}_{k , s}^{n} ( t ) \qquad ( Equation 23 )$$

The average data rate until time slot t over a window size of W is given by Equation 24.

$${\overline{R}}_{k}^{n} ( t ) = \frac{1}{W} {\sum }_{τ = t - W + 1}^{t} {R}_{k}^{n} ( τ ) \qquad ( Equation 24 )$$

Typically, the purpose of user scheduling in multi-cell OFDM networks is to maximize network-wide utility. The network-wide utility expressed by the sum of individual utilities Uₖⁿ is given by the following Equation 25.

$${max}_{I ( t )} U ( t ) = {\sum }_{n ∈ 𝒩} {\sum }_{k ∈ {𝒦}_{n}} {U}_{k}^{n} ( t ) , \\ subject to {\sum }_{k ∈ {𝒦}_{n}} {I}_{k , s}^{n} ( t ) \leq 1 , ∀ n ∈ 𝒩 , ∀ s ∈ 𝒮 \qquad ( Equation 25 )$$

Each individual utility for the existing PF scheduling that provides QoS can be expressed by the following Equation 26.

Uₖⁿ(t)=log R̅ₖⁿ(t) (Equation 26)

Unfortunately, it is difficult to reflect quality of service perceived by users by using R̅ₖⁿ, a QoS parameter. Therefore, the present invention proposes a QoE-aware PF scheduling method using MOS for the sake of each individual user's utility.

First of all, a basic MOS model is analyzed. The relationship between average data rate and MOS regarding real time video streaming service or file transfer protocol (FTP) service can be approximately modeled as a bounded logarithmic function according to the following Equation 27. That is, an MOS model of a real-time video streaming service and an MOS model of FTP service can be expressed by Equation 27:

$${MOS}_{k}^{n} ( {\overline{R}}_{k}^{n} ) = \{ \begin{matrix}1 \text{:} & {\overline{R}}_{k}^{n} \leq {R}_{1.0 , k}^{n} \\ \frac{1}{{a}_{k}^{n}} log \frac{{\overline{R}}_{k}^{n}}{{b}_{k}^{n}} \text{:} & {R}_{1.0 , k}^{n} < {\overline{R}}_{k}^{n} < {R}_{4.5 , k}^{n} \\ 4.5 \text{:} & {\overline{R}}_{k}^{n} \geq {R}_{4.5 , k}^{n}\end{matrix} \\ with 0 \leq {R}_{1.0 , k}^{n} < {R}_{4.5 , k}^{n} ∀ n ∈ 𝒩 , ∀ k ∈ {𝒦}_{n} \qquad ( Equation 27 )$$

where aₖⁿ and bₖⁿ are positive parameters that are derived by threshold data rates R_{1.0,k}ⁿ and R_{4.5,k}ⁿ for obtaining an MOS of 1 and an MOS of 4.5. The MOS function of Equation 27 is neither concave nor continuously differentiable. That is, it is difficult to obtain a globally optimum solution by performing scheduling according to Equation 25 using the MOS function of Equation 27. The MOS function shown in Equation 27 is not differentiable at R_{1.0,k}ⁿ and R_{4.5,k}ⁿ because the differential value is 0 in the ranges [0, R_{1.0,k}ⁿ] and [R_{4.5,k}ⁿ, ∞]. If user k has a data rate higher than R_{4.5,k}ⁿ, they do not require more resources to achieve a higher MOS because they already have a maximum MOS.

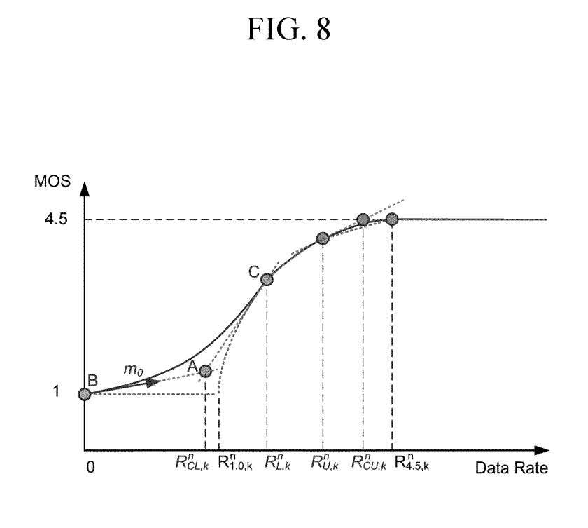

However, to avoid resource allocation problems, the zero gradient in the range [0, R_{1.0,k}ⁿ] should be carefully considered because the marginal utility in this range falls to zero. For example, if the average data rate R̅ₖⁿ of users is less than R_{1.0,k}ⁿ, users who are allocated resources according to PF scheduling may run into a deadlock. That is, no more resources are assigned to the users and therefore they remain under a starvation regime because the marginal utility in this range falls to 0. Accordingly, such a continuously differentiable MOS model as shown in FIG. 8 needs to be considered.

FIG. 8 is a view showing a continuously differentiable MOS model according to another exemplary embodiment of the present invention.

According to the current exemplary embodiment of the present invention, a new MOS function can be derived to avoid unfavorable starvation occurring in the basic MOS model, when solving an objective function in FIG. 24 to maximize network-wide utility. In the current exemplary embodiment of the present invention, the MOS function is remodeled to be continuously differentiable and to strictly increase in the data rate range [0, R_{4.5,k}ⁿ] by using a 2nd-order Bezier curve.

Referring to FIG. 8, an MOS curve suggested according to the current exemplary embodiment of the present invention includes two new curve segment ranges [0, R_{L,k}ⁿ] and [R_{U,k}ⁿ, R_{4.5,k}ⁿ] (indicated by solid lines), which are modifications of the original bounded logarithmic function (indicated by dotted lines).

First of all, the point A of intersection between two straight lines is determined to create a Bezier curve in the curved segment range ┌0, R_{L,k}ⁿ┐. The slope of the first straight line starting from point B (0,1) is m₀. The second straight line is tangent at point C (R_{L,k}ⁿ,MOSₖⁿ(R_{L,k}ⁿ)) on the original MOS curve. Accordingly, the Bezier curve in the curve segment range [0, R_{L,k}ⁿ] can be determined by a single parameter pε[0,1]. The points on the Bezier curve are the dividing points between point B and point A at the ratio of p:1−p and the dividing point between point A and point C at the ratio of p:1−p.

The Bezier curve in the range [R_{U,k}ⁿ,R_{4.5,k}ⁿ] can be created in a similar way.

The horizontal coordinate of point A is given by the following Equation 28.

$${R}_{CL , k}^{n} = \frac{- {m}_{L} {R}_{L , k}^{n} + {MOS}_{k}^{n} ( {R}_{L , k}^{n} ) - 1}{{m}_{0} - {m}_{L}} \qquad ( Equation 28 )$$

The horizontal coordinate of another intermediate point (R_{CU,k},4.5) on the Bezier curve is given by Equation 29.

$${R}_{CU , k}^{n} = \frac{4.5 - {MOS}_{k}^{n} ( {R}_{U , k}^{n} )}{{m}_{U}} + {R}_{U , k}^{n} \qquad ( Equation 29 )$$

Herein, m_{L} and m_{U} are the slopes of tangents at R_{L,k}ⁿ and R_{U,k}ⁿ respectively, which can be expressed by the following Equations 30 and 31, respectively.

$$\begin{matrix}{m}_{L} = \frac{1}{{a}_{k}^{n} {R}_{L , k}^{n}} & ( Equation 30 ) \\ {m}_{U} = \frac{1}{{a}_{k}^{n} {R}_{U , k}^{n}} & ( Equation 31 )\end{matrix}$$

As shown in Equation 32, a continuously differentiable MOS function [symbol] ₖⁿ( R̅ₖⁿ) determined by parameter pε[0,1] of the Bezier curve can be derived.

$${k}_{n}^{} ( {\overline{R}}_{k}^{n} ) = \{ \begin{matrix}\begin{matrix}{( 1 - p )}^{2} + 2 p ( 1 - p ) ( {m}_{0} {R}_{CL , k}^{n} + 1 ) + {p}^{2} {MOS}_{k}^{n} ( {R}_{L , k}^{n} ) ( 6 a ) \\ where {\overline{R}}_{k}^{n} = 2 p ( 1 - p ) {R}_{CL , k}^{n} + {p}^{2} {R}_{L , k}^{n} ( 6 b )\end{matrix} & if {\overline{R}}_{k}^{n} \leq {R}_{L , k}^{n} \\ \frac{1}{{a}_{k}^{n}} log \frac{{\overline{R}}_{k}^{n}}{{b}_{k}^{n}} ( 6 c ) & if {R}_{L , k}^{n} < {\overline{R}}_{k}^{n} < {R}_{U , k}^{n} \\ \begin{matrix}{( 1 - p )}^{2} {MOS}_{k}^{n} ( {R}_{U , k}^{n} ) + 2 p ( 1 - p ) 4.5 + {p}^{2} 4.5 ( 6 d ) \\ where {\overline{R}}_{k}^{n} = {( 1 - p )}^{2} {R}_{U , k}^{n} + 2 p ( 1 - p ) {R}_{CU , k}^{n} + {p}^{2} {R}_{4.5 k}^{n} ( 6 e )\end{matrix} & if {R}_{U , k}^{n} \leq {\overline{R}}_{k}^{n} < {R}_{4.5 k}^{n} \\ 4.5 & if {\overline{R}}_{k}^{n} \geq {R}_{4.5}^{n}\end{matrix} \qquad ( Equation 32 )$$

Referring to Equation 32, one advantage of Bezier curves is that the shapes of Bezier curves can be completely prescribed by a single parameter p. The value of p for calculating [symbol] ₖⁿ can be obtained from the value R̅ₖⁿ which is calculated from the quadratic formula of Equation 32. Also, for the sake of the strictly increasing characteristic of Bezier curves, the condition for R_{CL,k}ⁿ and R_{UL,k}ⁿ can be prescribed by Equations 33 and 34.

0≧R_{CL,k}ⁿ≦R_{L,k}ⁿ (Equation 33)

R_{U,k}ⁿ≦R_{CU,k}ⁿ≦R_{4.5,k}ⁿ (Equation 34)

In this instance, although the MOS model according to the current exemplary embodiment of the present invention may be expressed by Equation 32, the MOS model of the range [0,R_{L,k}ⁿ] or [R_{U,k}ⁿ,R_{4.5,k}ⁿ] alone may be used depending on a network administrator's policy.

In the MOS model according to the current exemplary embodiment of the present invention, a control parameter m₀ can be varied depending on network's administration policy. Also, if traffic load on the base station is high or depending on policy, the maximum quality of experience of each user can be limited. For example, by limiting quality of experience to a maximum of 4.0 when the maximum MOS is basically 4.5, resources can be utilized to minimize a decrease in the level of satisfaction of users who are already receiving high quality of experience and increase the quality of experience of other users. Alternatively, the quality of experience for high-priority users can be maintained at a maximum of 4.5, and the quality of experience for general users can be maintained at a value less than 4.5.

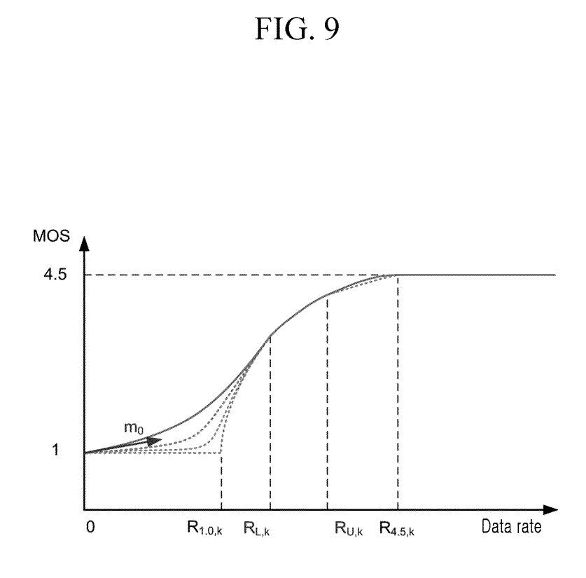

FIG. 9 is a view showing a plurality of MOS models using a varied control parameter m₀, according to another exemplary embodiment of the present invention.

Referring to FIG. 9, it can be seen that the Bezier curve shown in the MOS model is changed by controlling the slope at m₀ at R̅ₖⁿ=0. Moreover, it can be seen that the data rate is continuously differentiable and strictly increases in the range [0,R_{4.5,k}ⁿ].

Equation 35 represents a QoE-aware PF utility function using an MOS model according to the current exemplary embodiment of the present invention.

Uₖⁿ=log [ [symbol] ₖⁿ( R̅ₖⁿ)−1] (Equation 35)

In Equation 35, the logarithm of [symbol] ₖⁿ ( R̅ₖⁿ) minus 1 is taken because the minimum value of [symbol] ₖⁿ ( R̅ₖⁿ) is 1. When solving scheduling problems using the utility function of Equation 35, an optimal solution can be systematically obtained if the utility function is concave. When the sum of concave functions is concave, it is sufficient to check concavity of each utility function. In this instance, it is assumed that m₀ is 0 to provide a simple proof without loss of generality.

<Proposal 1>

Each utility function Uₖⁿ in Equation 35 proposed in the current exemplary embodiment of the present invention becomes concave if the lower Bezier bound R_{L,k}ⁿ satisfies the following condition.

$${b}_{k}^{n} {e}^{{a}_{k}^{n} + \frac{1}{3}} \leq {R}_{L , k}^{n} \leq {b}_{k}^{n} {e}^{{a}_{k}^{n} + 1} \qquad ( Equation 36 )$$

To prove that each utility Uₖⁿ is concave, the quadratic differential of Uₖⁿ in R̅ₖⁿε[0, R_{L,k}ⁿ] is negative or zero for all p⊂[0,1]. The following Equation 37 represents the quadratic differential of

$$\frac{{\partial }^{2} {U}_{k}^{n}}{\partial {\overline{R}}_{k}^{{n}^{2}}} = - \frac{2 p ( {R}_{L , k}^{n} - 2 {R}_{CL , k}^{n} ) + {R}_{CL , k}^{n}}{2 {{p}^{2} ( p ( {R}_{L , k}^{n} - 2 {R}_{CL , k}^{n} ) + {R}_{CL , k}^{n} )}^{3}} \qquad ( Equation 37 )$$

That is, Equation 37 becomes negative or zero for all pε[0,1] under the condition that Equation 38 is satisfied.

$$- \frac{2 {R}_{L , k}^{n} - 3 {R}_{CL , k}^{n}}{2 {( {R}_{L , k}^{n} - {R}_{CL , k}^{n} )}^{3}} \leq 0 \qquad ( Equation 38 )$$

Referring to FIG. 8, Equation 39 can be derived because R_{CL,k}ⁿ is less than R_{L,k}ⁿ.

R_{L,k}ⁿ≧3/2R_{CL,k}ⁿ (Equation 39)

Equation 39 can be simplified into Equation 40 by using Equation 28.

$${R}_{L , k}^{n} \geq {b}_{k}^{n} {e}^{{a}_{k}^{n} + \frac{1}{3}} \qquad ( Equation 40 )$$

Also, Equation 41 can be obtained by combining Equation 33 and Equation 28 together.

$${b}_{k}^{n} {e}^{{a}_{k}^{n}} \leq {R}_{L , k}^{n} \leq {b}_{k}^{n} {e}^{{a}_{k}^{n} + 1} \qquad ( Equation 41 )$$

Accordingly, the result of Equation 36 can be obtained by using Equation 40 and Equation 41. No other constraints were found even after the same procedure was applied to the ranges R̅ₖⁿε{[R_{L,k}ⁿ,R_{U,k}ⁿ], [R_{U,k}ⁿ,R_{4.5,k}ⁿ], [R_{4.5,k}ⁿ,∞]}.

A QoE-aware PF scheduling method according to another exemplary embodiment of the present invention will be described below.

By using a concave QoE-aware PF utility function with the constraint of R_{L,k}ⁿ of Equation 36 according to the current exemplary embodiment of the present invention, the user scheduling problem for network-wide utility maximization (see Equation 25) expressed by the sum of individual utilities Uₖⁿ on a multi-cell OFDM network can be presented as the following optimization problem. In the current exemplary embodiment of the present invention, the optimization problem is defined as a matter of maximizing the sum of the logarithms of the QoE of users, in order to maximize average quality of experience and achieve fairness among users.

$${max}_{I ( t )} U ( t ) = {\sum }_{n ∈ 𝒩} {\sum }_{k ∈ {𝒦}_{n}} log ( {k}_{n}^{} ( {\overline{R}}_{k}^{n} ) - 1 ) \\ subject to {\sum }_{k ∈ {𝒦}_{n}} {I}_{k , s}^{n} ( t ) \leq 1 , ∀ n ∈ 𝒩 , ∀ s ∈ 𝒮 \qquad ( Equation 42 )$$

By applying gradient scheduling to the above scheduling problem according to the above-explained <Proposal 1>, the scheduling problem can be simplified as a matter of scheduling users on subchannel s by each BSₙ.

$${max}_{I ( t )} {\sum }_{k ∈ {𝒦}_{n}} \frac{∇ {k}_{n}^{} ( {\overline{R}}_{k}^{n} )}{{k}_{n}^{} ( {\overline{R}}_{k}^{n} ) - 1} {I}_{k , s}^{n} ( t ) {r}_{k , s}^{n} ( t ) \\ subject to {\sum }_{k ∈ {𝒦}_{n}} {I}_{k , s}^{n} ( t ) \leq 1 \qquad ( Equation 43 )$$

In conclusion, QoE-aware user scheduling performed on subchannel s by each BSₙ can be optimized by determining Equation 44.

$${I}_{k , s}^{n} ( t ) = \{ \begin{matrix}1 , & if k = arg {max}_{k ∈ {𝒦}_{n}} \frac{∇ {k}_{n}^{} ( {\overline{R}}_{k}^{n} )}{{k}_{n}^{} ( {\overline{R}}_{k}^{n} ) - 1} {r}_{k , s}^{n} ( t ) \\ 0 , & otherwise\end{matrix} \qquad ( Equation 44 )$$

When the scheduler of a base station allocates resources, with an awareness of average quality of experience and fairness among users, an expected value of quality-of-experience improvement (marginal utility of MOS) and the current channel state can also be taken into consideration according to Equation 44. For example, if the current quality of experience of a particular user is lower than those of other users, the scheduler of the base station using Equation 44 can increase fairness among the users by raising the priority of that user. If there is any user who is expected to experience significant improvement in quality of experience provided that every user receives the same amount of resources, or the channel state of a particular user is better than the channel state of other users, the scheduler of the base station can improve the MOS of the entire system by raising the priority of that user.

A scheduling technique according to the current exemplary embodiment of the present invention can be easily expanded into multi-cell environments. A QoE-aware PF utility (see Equation 35) is a concave function with the constraint of Equation 36. Therefore, techniques such as adaptive fractional time reuse (adaptive FTR) for inter-cell interference coordination can be applied to the scheduling technique according to the current exemplary embodiment of the present invention. In adaptive FTR, time resources are partitioned, and a signal is transmitted at high power in different partitions for neighboring cells in order to reduce inter-cell interference. A resource partitioning ratio Φ=(φ₀, . . . , φ_{L}) where Σ_{I-0}^{L}=1 can be adaptively determined to maximize a network-wide objective function for each time slot under a dynamic network condition.

To this end, first of all, QoE-aware intra-cell user scheduling (I_{k,s,l}ⁿ) is performed using Equation 44 for each time slot corresponding to a partition lε [symbol] =={0, . . . , L}. Next, information about the average user scheduling and data rate for partition R̅_{k,l}ⁿ is calculated. It is apparent that the data rate R̅ₖⁿ is a function of resource partitioning ratio Φ, and accordingly the inter-cell resource partitioning problem can be expressed by Equation 45.

$${max}_{Φ} {\sum }_{n ∈ 𝒩} {\sum }_{k ∈ {𝒦}_{n}} log ( {k}_{n}^{} ( {\overline{R}}_{k}^{n} ( Φ ) ) - 1 ) \\ subject to {\sum }_{l ∈ ℒ} {φ}_{l} = 1 \qquad ( Equation 45 )$$

Then, the optimal resource partitioning ratio φₗ to be used for the next time slot T can be expressed by the following Equation 46 using the previous partitioning ratio Φ.

$${φ}_{l}^{*} = \frac{{\sum }_{n ∈ 𝒩} {D}_{l}^{n}}{{\sum }_{l ∈ ℒ} {\sum }_{n ∈ 𝒩} {D}_{l}^{n}} \\ Herein , \\ {D}_{l}^{n} = {\sum }_{k ∈ {𝒦}_{n}} \frac{∇ {k}_{n}^{} ( {\overline{R}}_{k}^{n} ( Φ ) )}{{k}_{n}^{} ( {\overline{R}}_{k}^{n} ) - 1} {\overline{I}}_{k , l}^{n} {\overline{R}}_{k , l}^{n} \qquad ( Equation 46 )$$

In this instance, the QoE-aware inter-cell resource partitioning ratio φ is determined not by the data rate itself but by marginal utility represented by MOS. Therefore, in the present invention, inter-cell interference coordination is performed to improve quality of experience of users.

In the current exemplary embodiment of the present invention, the quality of experience of users at cell boundaries can be improved by using QoE-based adaptive interference coordination, instead of adaptive FTR, which is one of the existing QoS-based interference coordination techniques.

QoE-aware PF scheduling according to the current exemplary embodiment of the present invention is also applicable to joint user scheduling and power control. To this end, QoE-aware intra-cell user scheduling is performed using Equation 44, and QoE-aware power control is performed using Equation 47:

$${p}_{s}^{n} ( t ) = \frac{∇ {k}_{n}^{} ( {\overline{R}}_{k}^{n} )}{{k}_{n}^{} ( {\overline{R}}_{k}^{n} ) - 1} \frac{1}{{t}_{s}^{n} + {λ}^{n} ln 2} - \frac{{σ}^{2} + {\sum }_{j = 1 , j \neq n}^{N} {p}_{s}^{j} ( t ) {G}_{k ( n , s ) , s}^{j} ( t )}{{G}_{k ( n , s ) , s}^{n} ( t )} \\ where \\ {t}_{s}^{n} = {\sum }_{j = 1 , j \neq n}^{N} \frac{∇ {k ( j , s )}_{i}^{} ( {\overline{R}}_{k ( j , s )}^{j} )}{{k ( j , s )}_{i}^{} ( {\overline{R}}_{k ( j , s )}^{i} ) - 1} ( {R}_{k ( j , s )}^{j} ) \cdot \frac{{G}_{k ( j , s ) , s}^{n} ( t ) {SINR}_{k ( j , s ) , s}^{j} ( t )}{{σ}^{2} + {\sum }_{m = 1}^{N} {p}_{s}^{m} ( t ) {G}_{k ( j , s ) , s}^{m} ( t )} \\ {λ}^{T} ( {P}^{n} - {\sum }_{s ∈ 𝒮} {p}_{s}^{n} ) = 0 \qquad ( Equation 47 )$$

and where k(j,s) indicates the user BS j allocates to subchannel s.

Accordingly, in the current exemplary embodiment of the present invention, the quality of experience of users at cell boundaries can be improved by using QoE-aware dynamic joint user scheduling and power control, instead of joint user scheduling and power control, which is one of the existing QoS-aware interference coordination techniques.

The QoE-aware PF utility function given in Equation 35 is applicable as in the following example. wₖ(wₖ≧0) indicates the priority of user k.

Uₖⁿ= [symbol] ₖⁿ(Rₖⁿ) (Equation 48)

Equation 48 is a modification of the QoE-aware PF utility function of Equation 35 which takes into consideration average quality of experience maximization.

Uₖⁿ=wₖ log [ [symbol] ₖⁿ( R̅ₖⁿ)] (Equation 49)

Equation 49 is a modification of the QoE-aware PF utility function of Equation 35 which takes into consideration average quality of experience maximization and fairness among users.

Uₖⁿ=wₖ log [ [symbol] ₖⁿ( R̅ₖⁿ)−1] (Equation 50)

Equation 50 is a modification of the QoE-aware PF utility function of Equation 35 which takes into consideration average quality of experience maximization, fairness among users (concave function), and user priority (i.e., Equation 35+user priority).

Uₖⁿ=wₖ(1−α)⁻¹( [symbol] ₖⁿ(Rₖⁿ)−1)^{1-α} (Equation 51)

Equation 51 is a QoE-aware generalized proportional fair utility function, which is a modification of the QoE-aware PF utility function of Equation 35 which takes into consideration fairness of MOS among users by adjusting the parameter α, i.e., a fairness factor for users.

Table 5 shows a simulation environment for evaluating a QoE-aware scheduling method according to another exemplary embodiment of the present invention.

TABLE 5

| Parameter | Assumed value |
|---|---|
| cell layout | 19 hexagonal cells |
| cell coverage radius | 1000 meters |
| number of subchannels | 16 |
| carrier frequency | 2.3 GHz |
| system bandwidth | 10 MHz |
| thermal noise density | −174 dBm/H |
| target BER | 0.001 |
| time slot length | 1 ms |
| maximum transmission | 20 W |
| power | |
| radio loss model | PL(dₖ) = 16.62 + 37.6 1og₁₀(dₖ[m]) [dB] |
| channel model | Jakes' Rayleigh fading model |
| user distribution | uniform distribution |
| simulation time | 10,000 time slots |
| performance comparison | MOS |
| | MOS of bottom 5% |

Table 6 shows a scenario for performance analysis of a scheduling method according to another exemplary embodiment of the present invention, and Table 7 shows the parameters of an MOS model for performance analysis of a scheduling method according to the other exemplary embodiment of the present invention.

According to the scenario of Table 6, each user group is served with a different video service. Table 7 shows the parameters for the characteristics of each video service.

TABLE 6

| Scenario | Parameter | Setting |
|---|---|---|
| Scenario 1 | Number of user group | 1 |
| | Application | Container |
| Scenario 2 | Number of user group | 2 |
| | User ratio for each group | 5:5 |
| | Application for the group 1 | News |
| | Application for the group 2 | Container |
| Scenario 3 | Number of user group | 3 |
| | User ratio for each group | 4:3:3 |
| | Application for the group 1 | Foreman |
| | Application for the group 2 | Mother |
| | Application for the group 3 | News |

TABLE 7

| Video name | R_{1.0,k}ⁿ | R_{4.5,k}ⁿ |
|---|---|---|
| Foreman | 120 | 2,156 |
| Mother | 17 | 447 |
| news | 58 | 638 |
| Container | 53 | 1,159 |
| Salesman | 57 | 2,265 |
| Bus | 592 | 4,141 |
| City | 169 | 2,202 |
| Crew | 178 | 2,677 |

In this simulation, the MOS of the bottom 5% was used. The QoE-aware scheduling method according to the current exemplary embodiment of the present invention was compared with the existing PF scheduling method to analyze the performance of this method, and performance analysis was performed while increasing the number of users per cell from 10 to 40.

As in Table 6, users are divided into three groups and each user group is served with a different service, and as in Table 7, each service has different service requirements to offer satisfactory quality of service

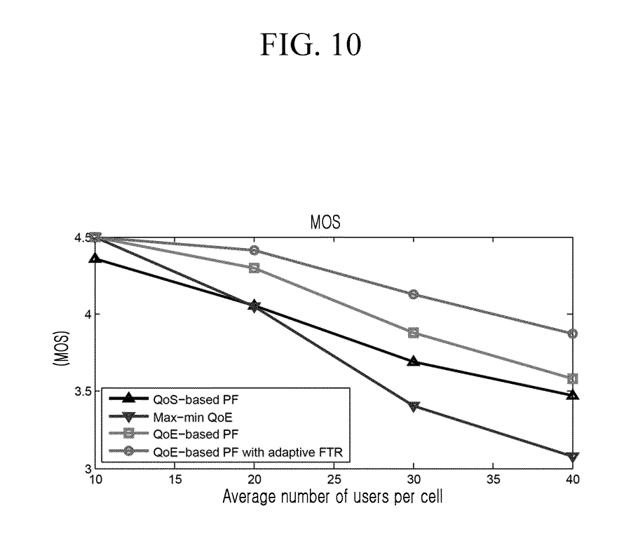

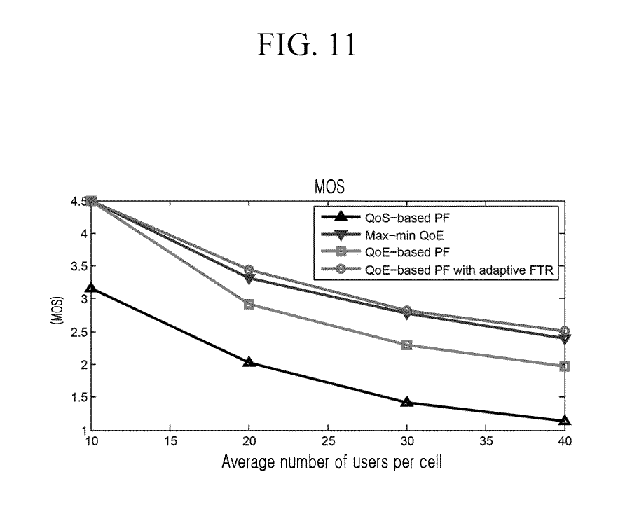

FIG. 10 is a view showing the MOS performance versus the number of cell users in heterogeneous user groups, and FIG. 11 is a view showing the MOS performance of the bottom 5% versus the number of cell users in heterogeneous user groups.

In the simulation of FIG. 10 and FIG. 11, 30% of the users are receiving ‘Foreman’ video service, 40% of the users are receiving ‘News’ real-time video streaming service, and 30% of the users are FTP users. R_{4.5,k}ⁿ of each user group is 2156 kbps, 638 kbps, and 300 kbps, respectively. In the simulation of FIG. 10 and FIG. 11, a total of four scheduling methods including QoS-aware PF scheduling, MAX-min QoE scheduling, QoE-aware PF scheduling according to the current exemplary embodiment of the present invention, and QoE-aware PF scheduling using adaptive FTR according to the current exemplary embodiment of the present invention were compared for performance analysis.

Compared to the QoS-aware PF scheduling, the QoE-aware PF scheduling according to another exemplary embodiment of the present invention and the QoE-aware PF scheduling using adaptive FTR according to another exemplary embodiment of the present invention maintain optimal performance at MOS, and show significant improvement in performance of up to 200% at the MOS of the bottom 5%. Compared to the MAX-min QoE scheduling, these methods show significant improvement in performance even at MOS and further significant improvement in performance at the MOS of the bottom 5%.

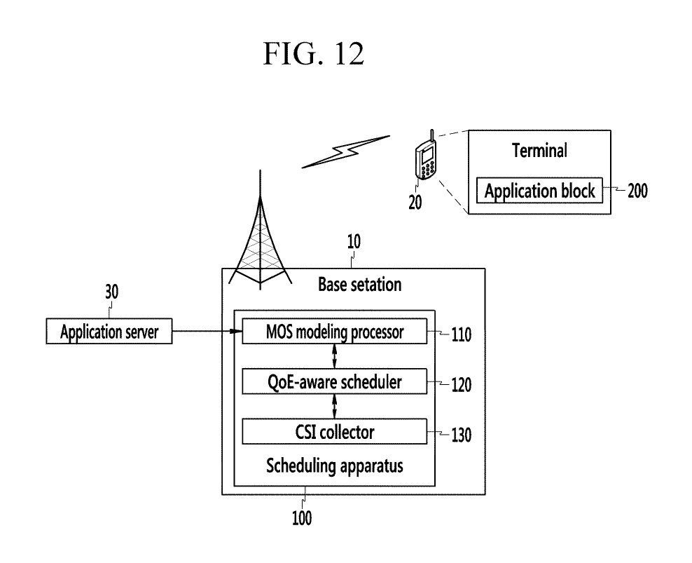

FIG. 12 is a view showing a system to which a scheduling method according to an exemplary embodiment of the present invention is applied. The system according to the exemplary embodiment of the present invention includes a base station 10, a terminal 20, and an application server 30. A scheduling apparatus 100 according to an exemplary embodiment of the present invention may be set up at the base station or connected apart from the base station. The scheduling apparatus 100 according to the exemplary embodiment of the present invention includes an MOS modeling processor 110, a QoE-aware scheduler 120, and a CSI collector 130. The terminal 20 includes an application block 200.

When the user's terminal starts a service, the application block 200 collects service requirements information about the service started on the terminal. The requirements information may be the minimum data rate R_{1.0,k} for getting the terminal to run an application, the maximum data rate R_{4.5,k} required for the user to receive highest-quality service, etc. In this instance, the application block 200 can obtain necessary information through a protocol like dynamic adaptive streaming over HTTP (DASH) using 3GPP HTTP between the application server 30 and the application block 200.

Afterwards, the application server or the terminal delivers application information such as an application parameter to the base station.

The MOS modeling processor 110 of the base station creates an MOS model using an application parameter. The MOS modeling processor 110 according to the exemplary embodiment of the present invention may create an MOS model as shown in FIGS. 4 and 5 or as shown in FIGS. 8 and 9. In this instance, the QoE-aware scheduler 120 manages a MOS function model while service continues according to each user's application. The terminal periodically transmits CSI (e.g., channel quality information, i.e., CQI, in LTE) indicating its channel state, and the CSI collector 130 of the base station collects the terminal's CSI.

Afterwards, the QoE-aware scheduler 120 performs scheduling according to Equation 19 or Equation 44. Accordingly, the QoE-aware scheduler 120 can schedule network resources, with comprehensive consideration given to an expected average value of quality of experience, the current channel state, and fairness among users. Moreover, the QoE-aware scheduler 120 continuously updates information about the MOS and average data rate measured of users who are currently receiving service, and uses it as scheduling information.

The scheduling method and apparatus according to an exemplary embodiment of the present invention can improve quality of experience when scheduling limited radio resources, by using a continuously differentiable MOS model and taking into consideration the characteristics of mobile service provided to a user, the performance of a mobile terminal, the current channel state, and fairness among users.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A QoE-aware scheduling method for a wireless network, the method comprising:
acquiring application information about a service to be run on a terminal included in the wireless network;
creating a mean opinion score (MOS) model based on the application information; and
scheduling wireless network resources for the terminal based on the MOS model.

2. The method of claim 1, wherein the creating of an MOS model comprises:
determining a plurality of curve segment ranges each including non-differentiable points in a first MOS model expressed by a non-differentiable function; and
deleting the non-differentiable points by applying an n-th Bezier curve to each of the curve segment ranges.

3. The method of claim 2, wherein the deleting of the non-differentiable points comprises:
determining (n+1) control points in each of the curve segment ranges; and
drawing an n-th Bezier curve by joining the (n+1) control points and determining the drawn n-th Bezier curve as the MOS model for each of the curve segment ranges.

4. The method of claim 2, wherein the MOS model is expressed by a Bezier curve parameter and a function of data rate in a wireless network, which is continuously differentiable in the entire range of data rates.

5. The method of claim 1, wherein the scheduling comprises:
receiving CSI from the terminal; and
calculating the data rate available on every subchannel allocated to the user based on the CSI.

6. The method of claim 5, wherein the scheduling further comprises:
calculating an average data rate using a scheduling indicator vector and an available data rate; and
scheduling wireless network resources based on the user's priority, the MOS model, and the average data rate

7. The method of claim 6, wherein the scheduling comprises applying a gradient scheduling technique to the user's priority, the MOS model, and the average data rate.

8. The method of claim 6, wherein the scheduling indicator vector is 0 if a base station allocates a specific subchannel and a specific time slot to the user, and otherwise is 1.

9. A QoE-aware scheduling apparatus for a wireless network, the apparatus comprising:
an MOS modeling processor that acquires application information about a service run on a terminal included in the wireless network and creates an MOS model based on the application information; and
a QoE-aware scheduler that schedules wireless network resources for the terminal based on the MOS model.

10. The apparatus of claim 9, wherein the MOS modeling processor determines a plurality of curve segment ranges each including non-differentiable points in an existing MOS model expressed by a non-differentiable function, and deletes the non-differentiable points by applying an n-th Bezier curve to each of the curve segment ranges.

11. The apparatus of claim 10, wherein the MOS modeling processor determines (n+1) control points in each of the curve segment ranges, draw an n-th Bezier curve by joining the (n+1) control points, and determines the drawn n-th Bezier curve as the MOS model for each of the curve segment ranges.

12. The apparatus of claim 10, wherein the MOS model is expressed by a Bezier curve parameter and a function of data rate in a wireless network, which is continuously differentiable in the entire range of data rates.

13. The apparatus of claim 9, further comprising a CSI collector that receives CSI from the terminal,
wherein the QoE-aware scheduler calculates the data rate available on every subchannel allocated to the user based on the CSI.

14. The apparatus of claim 13, wherein the QoE-aware scheduler calculates an average data rate using a scheduling indicator vector and an available data rate, and schedules wireless network resources based on the user's priority, the MOS model, and the average data rate.

15. The apparatus of claim 14, wherein the QoE-aware scheduler applies a gradient scheduling technique to the user's priority, the MOS model, and the average data rate.

16. The apparatus of claim 14, wherein the scheduling indicator vector is 0 if a base station allocates a specific subchannel and a specific time slot to the user, and is otherwise 1.

17. A QoE-aware scheduling method for a wireless network, the method comprising:
creating an MOS model based on application information about a service to be run on a terminal included in the wireless network;
generating a proportional fair (PF) utility function based on the MOS model; and
scheduling wireless network resources for the terminal based on the PF utility function.

18. The method of claim 17, wherein the generating of a PF utility function comprises generating a concave PF utility function.

19. The method of claim 17, wherein the scheduling comprises scheduling wireless network resources for the terminal based the utility function by using adaptive fractional time reuse (adaptive FTR).

20. The method of claim 17, wherein the scheduling comprises:
modifying the PF utility function by taking into consideration at least one of average quality of experience, a fairness factor for users, and user's priority; and
scheduling wireless network resources for the terminal based on the modified utility function.
